(19) United States
(12) Patent Application Publication
(10) Pub. No.: US 2017/0201334 A1
(43) Pub. Date: Jul. 13, 2017

(54) Direct Measurement of Reflected Waves of Multi-Port Antennas by Using Circulators

(71) Applicant: University of Manitoba, Winnipeg (CA)

(72) Inventors: Ali M. Mehrabani, Winnipeg (CA); Lot Shafai, Winnipeg (CA)

(21) Appl. No.: 15/399,917

(22) Filed: Jan. 6, 2017

Related U.S. Application Data
(60) Provisional application No. 62/277,679, filed on Jan. 12, 2016.

(51) Int. Cl. H04B 17/10; H04B 17/18

(52) U.S. Cl. CPC H04B 17/103; H04B 17/18

(57) ABSTRACT

Power of reflected waves of a multi-port antenna apparatus is measured by connecting a circulator between the respective output of the multi-output feeding network and the multi-port antenna. Each circulator has a plurality of ports where the output signal from the network is communicated to a first port of through the circulator and from the second port of the circulator to the respective port of the multi-port antenna and such that the reflected waves from the respective port of the multi-port antenna are communicated back to the second port of the circulator and through the circulator to a third port of the circulator and measuring the reflected waves from a selected one of the ports of the multi-port antenna by connecting the third port of the respective circulator to a vector network analyzer while connecting each of the third ports of the remaining circulators to a standard matching load.

This application claims the benefit under 35 USC 119 (e) of Provisional application 62/277,679 filed Jan. 12, 2016.

This invention relates to a method for directly measuring the power of reflected waves of multi-port antennas by using circulators. This method can be used in a multi-port antennas system to directly measure reflected powers without disturbing the antenna radiation function. The Invention is also directed to an apparatus for measurement of the power of reflected waves of a multi-port antenna apparatus and to the multi-port antenna apparatus using the method.

### BACKGROUND OF THE INVENTION

Multi-port devices have been extensively used in RF and microwave engineering. In antenna engineering and applied electromagnetic fields, they are equally popular and well-known as multi-port antennas. They are widely used and applied to any transmitting or receiving antenna having multiple inputs. Essentially, a multi-port antenna acts as a power combiner in transmit mode and a divider in receive mode.

As is well known, technically, a multi-port antenna has many great features that are beneficial in RF and microwave systems. They are potentially multi-function antennas with reconfigurable radiation and polarization capabilities, resulting in Increased channel capacity of the radio link, providing adaptive signal-processing tools at the RF front-end to improve signal to noise ratio, better immunity and protection to unwanted interference and Jamming signals using adaptive nulling technique, and many more.

Angular distributions of radiated electromagnetic waves and the amount of the delivered power are the two most important criteria in any wireless communication system. The angular distribution is the Fourier transformation of the electric field distributions across the aperture of the radiating element in the far-field zone. For a given distance and input power, the delivered power strictly depends on the Impedance matching of the antenna input.

Thus, it is of great importance to be able to measure the reflected waves at the antenna input as the antenna performs in its designed radiation mode.

Relation between Reflection Coefficient and reflected power:

delivered power to port i=Incident power at port i−reflected power at port i

Reflection Coefficient (ρᵢ) at port i is related to incident and reflected powers in following way:

$${\vert {ρ}_{i} \vert}^{2} = \frac{reflected power at port i}{incident power at port i}$$

As is well known, knowledge of the value of the reflection coefficient in an antenna system is highly desirable to properly manage the antenna system using information of the value of the reflection coefficient. This information can be used in modification or design of the antenna system. In other arrangements the value can be detected in order to ensure that it does not get too high with the potential of damage to the system. In such an event, this information can be used to operate a protection suppression system which maintains operation while acting to reduce or ameliorate the reflection coefficient. In other arrangements the detection of a reflection coefficient over a predetermined value can be used to shut down the system to avoid damage.

For single-port antennas, the approach to measure reflection coefficient is very straightforward. The input of the antenna under test is connected to a Vector Network Analyzer (VNA) and the reflected waves can be readily measured.

A Vector Network Analyzer (VNA) is a well-known device and is commonly used to measure both amplitude and phase of reflected and transmitted powers. Many examples are available from different manufacturers and many of these examples can be used herein.

However, for a multi-port antenna, the measurement is quite complicated. From microwave engineering point of view, the standard procedure is to apply the single-port method by matching all other inputs to the standard loads. Unfortunately, this is not the case for a multi-port radiating element. The reason Is that the radiation properties of the antenna will change, when the rest of the ports are matched. For example, proper feeding networks with appropriate amplitude and phase excitations are required for multi-function and multi-mode antennas. Thus, it is required to maintain the antenna patterns, while measuring the reflected waves at each port.

### SUMMARY OF THE INVENTION

According to a first aspect of the Invention there is provided a method for measurement of the power of reflected waves of a multi-port antenna apparatus,

wherein the antenna apparatus comprises a multi-port antenna and a multi-output feeding network arranged such that a respective output signal of the network is supplied to a respective port of the multi-port antenna;

the method comprising:

connecting a respective circulator between the respective output of the multi-output feeding network and the multi-port antenna;

each circulator having a plurality of ports arranged such that the output signal from the multi-output feeding network is communicated to a first port of through the circulator and from the second port of the circulator to the respective port of the multi-port antenna and such that the reflected waves from the respective port of the multi-port antenna are communicated back to the second port of the circulator and through the circulator to a third port of the circulator;

and measuring the reflected waves from a selected one of the ports of the multi-port antenna by connecting the third port of the respective circulator to a vector network analyzer while connecting each of the third ports of the remaining circulators to a standard matching load.

According to a second aspect of the invention there is provided a multi-port antenna apparatus comprising:

a multi-port antenna;

a multi-output feeding network arranged such that a respective output signal of the network is supplied to a respective port of the multi-port antenna;

a respective circulator connected between the respective output of the multi-output feeding network and the multi-port antenna;

each circulator having a plurality of ports arranged such that the output signal from the multi-output feeding network is communicated to a first port of through the circulator and from the second port of the circulator to the respective port of the multi-port antenna and such that the reflected waves from the respective port of the multi-port antenna are communicated back to the second port of the circulator and through the circulator to a third port of the circulator;

a vector network analyzer for measuring the reflected waves from a selected one of the ports of the multi-port antenna by connecting the third port of the respective circulator while connecting each of the third ports of the remaining circulators to a standard matching load

and a control device for using the measurement of the power of the reflected waves to calculate a value reflection coefficient for all ports of the multi-port antenna and for using the value to effect safety and protection of the RF front-end circuitry and the antenna unit.

In general therefore as described in more detail hereinafter there is provided a novel approach to directly measure the reflected wave of a multi-port antenna, without having disturbed its normal radiation. This provides direct information on the reflected and delivered powers to the antenna, that is the reflection coefficient.

In this approach, a microwave component, which is known as a circulator, connects each of the outputs of the feeding network to the respective antenna Input. Thus, the forward wave passes through the respective circulator and excites each port of the antenna, as if it would have been directly fed through feeding matrix.

The term circulator is a generic term for a passive non-reciprocal three-port device, in which a microwave or radio frequency signal entering any port is transmitted to the next port in rotation only. A port in this context is a point where an external waveguide or transmission line (such as a microstrip line or a coaxial cable), connects to the device. For a three-port circulator, a signal applied to port 1 only comes out of port 2; a signal applied to port 2 only comes out of port 3; and a signal applied to port 3 only comes out of port 1. Many different forms of such a generic device are available. Thus the reflected wave of the selected port of the multi-port antenna which is returned to the second port 2 of the circulator is directed only to the third port 3 of the circulator. As a result, the reflected wave of this selected port of the multi-port antenna is directly communicated to and easily measured by a VNA. Now, during measurement of this selected port of the multi-port antenna, instead of directly matching the other ports of the antenna, the Isolated ports, or third ports, of the other circulators are matched to the standard loads. Hence, the Impedance mismatch will be measured, while the multi-port antenna operates in its designed radiation mode.

In some cases where the antenna is symmetrical in construction, the measurement only at one port is required on the assumption that the remainder are symmetrical and Identical.

In other non-symmetrical systems it is necessary to separately check each port in turn, in which case the circulator of each port in turn is used in the detection of the reflected wave from the respective port of the antenna while the other ports of the antenna are connected through their respective circulator to the feeding network.

Many arrangements of Vector Network Analyzer (VNA) include multiple ports where each port is connected to a standard load of for example 50 ohms. Thus in the four port antenna example, each port of the antenna is connected through its respective circulator to a respective port of the Vector Network Analyzer (VNA) and the output is measured in turn. The proposed method can be also applied to an n-port antenna structure and in the event that there are more antenna ports than ports of the Vector Network Analyzer (VNA), suitable connection and disconnection is used.

The purpose of this invention is to realistically measure the power of the reflected waves of multi-port antennas, while simultaneously retaining their radiation functions. As set forth above, the reported techniques in the literature considerably disturb the radiation modes of multi-port antennas and thus are not realistic indications of antenna mismatch loss in practice. The aforementioned mismatch losses are of paramount importance, particularly due to the increasing demand for low-power wireless devices used in many applications such as health monitoring devices, Radio Frequency Identifications or RFID, cellular phones, and commercial and military radar systems.

The arrangement herein provides a scientific and practical basis for directly measuring the scattering parameters of multi-port antennas in their designed radiation modes. The concept makes use of a microwave component, that is, a circulator, to effectively isolate the ports from the measurement set-up, without having disturbed the antenna radiation functions. As such, it provides a safe and real-time measurement of the reflected waves at the device inputs, while it fully performs in its operational mode.

The arrangement disclosed herein can be applied to all low power wireless devices, particularly multi-port devices, used in variety of applications such as health monitoring devices, GPS, Radio Frequency Identifications or RFID, cellular phones, and synthetic aperture radars.

### BRIEF DESCRIPTION OF THE DRAWINGS

One embodiment of the invention will now be described in conjunction with the accompanying drawings in which:

FIG. 1 is a block diagram for a four-port antenna including components for measuring the reflected waves for use in a method according to the present invention.

In the drawings like characters of reference indicate corresponding parts in the different FIGURES.

### DETAILED DESCRIPTION

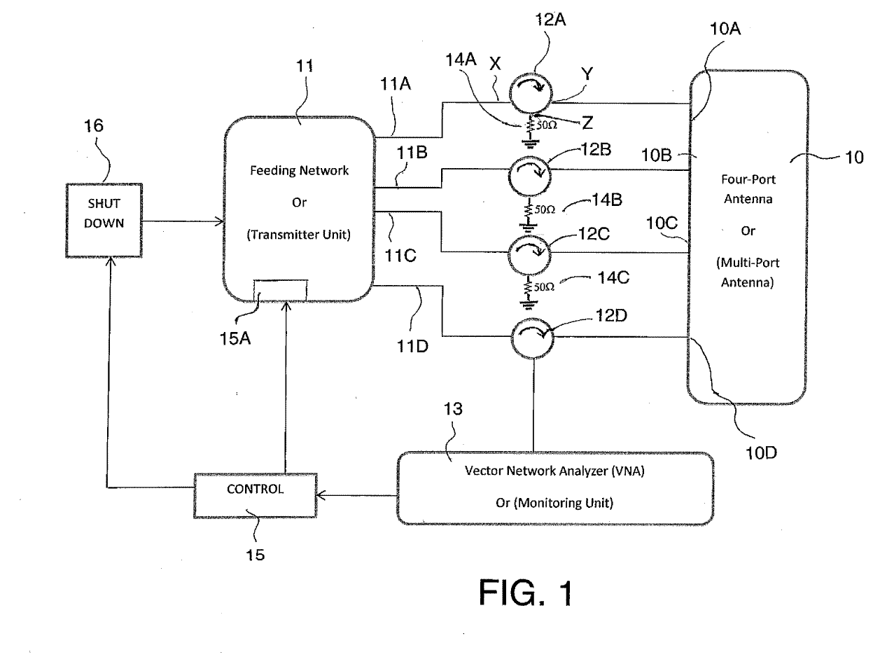

In FIG. 1 is shown a four-port antenna apparatus comprising a multi-port antenna 10 with four ports 10A to 10D and a multi-output feeding network 11 with four outputs 11A to 11D. The outputs are arranged such that a respective output signal of the network is supplied to excite a respective port of the multi-port antenna.

The apparatus is modified to include a respective circulator 12A to 12D connected between the respective output of the multi-output feeding network and the multi-port antenna. Thus, the forward wave from the output passes through the circulator and excites each port of the antenna, as if it would have been directly fed through feeding matrix.

Each circulator has three ports X, Y and Z arranged such that the output signal from the multi-output feeding network is communicated to a first port of through the circulator and from the second port of the circulator to the respective port of the multi-port antenna and such that the reflected waves from the respective port of the multi-port antenna are communicated back to the second port of the circulator and through the circulator to a third port of the circulator. It should be noted that the overall lengths of the connecting cable between the feeding networks and the multi-port antenna are assumed identical.

Thus the reflected wave is directed only to the third port of the circulator. As a result, it can be easily measured by a VNA 13 at the third port Z of the circulator 12D. Now, instead of directly matching other ports 10A to 10C, the isolated ports, or third ports, of the other circulators 12A to 12C are matched to the standard loads 14A to 14C, as shown below. Hence, the Impedance mismatch will be measured, while the multi-port antenna operates in its designed radiation mode.

The method of the present invention can be implemented by commercialization of a combination of the required circulator or circulators and the Vector Network Analyzer (VNA) for installation in a separate or pre-existing antenna system. Alternatively the method can also be implemented by installation of the system in an antenna system where the output from the Vector Network Analyzer (VNA) of the reflection coefficient is used in a control system 15 to ensure, by controlling the feeding network 11, that the coefficient does not get too high with the potential of damage to the system. In such an event, this information can be used to operate a protection suppression system 15A which maintains operation while acting to reduce the reflection coefficient or ameliorate the effects thereof or to effect safety and protection of the RF front-end circuitry and the antenna unit. In other arrangements the detection of a reflection coefficient over a predetermined value can be used to shut down the system at a shutdown control 16 to avoid damage.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method for measurement of the power of reflected waves of a multi-port antenna apparatus,
wherein the antenna apparatus comprises a multi-port antenna and a multi-output feeding network arranged such that a respective output signal of the network is supplied to a respective port of the multi-port antenna;
the method comprising:
connecting a respective circulator between the respective output of the multi-output feeding network and the multi-port antenna;
each circulator having a plurality of ports arranged such that the output signal from the multi-output feeding network is communicated to a first port of through the circulator and from the second port of the circulator to the respective port of the multi-port antenna and such that the reflected waves from the respective port of the multi-port antenna are communicated back to the second port of the circulator and through the circulator to a third port of the circulator;
and measuring the reflected waves from a selected one of the ports of the multi-port antenna by connecting the third port of the respective circulator to a vector network analyzer while connecting each of the third ports of the remaining circulators to a standard matching load.

2. The method according to claim 1 wherein the reflected waves from each one of the ports of the multi-port antenna in turn are measured by using the circulator of each output in turn while the other ports of the antenna are connected through their respective circulator to the matching load.

3. The method according to claim 1 wherein the reflected waves are measured while the multi-port antenna operates in its designed radiation mode.

4. The method according to claim 1 wherein the measurement of the reflected waves is used to calculate an Impedance mismatch for each port of the multi-port antenna.

5. The method according to claim 1 wherein the measurement of the reflected waves is used to operate a control device for using the measurement of the power of the reflected waves to calculate a value reflection coefficient for all ports of the multi-port antenna and for using the value to effect safety and protection of the RF front-end circuitry and the antenna unit.

6. The method according to claim 1 wherein the measurement of the reflected waves is used to operate a shut down the system at a shutdown control to avoid damage

7. An apparatus for measurement of the power of reflected waves of a multi-port antenna apparatus,
wherein the antenna apparatus comprises a multi-port antenna and a multi-output feeding network arranged such that a respective output signal of the network is supplied to a respective port of the multi-port antenna;
the apparatus comprising:
a respective circulator for connection between the respective output of the multi-output feeding network and the multi-port antenna;
each circulator having a plurality of ports arranged such that the output signal from the multi-output feeding network is communicated to a first port of through the circulator and from the second port of the circulator to the respective port of the multi-port antenna and such that the reflected waves from the respective port of the multi-port antenna are communicated back to the second port of the circulator and through the circulator to a third port of the circulator;
and a vector network analyzer for measuring the reflected waves from a selected one of the ports of the multi-port antenna by connecting the third port of the respective circulator while connecting each of the third ports of the remaining circulators to a standard matching load.

8. A multi-port antenna apparatus comprising:
a multi-port antenna;
a multi-output feeding network arranged such that a respective output signal of the network is supplied to a respective port of the multi-port antenna;
a respective circulator connected between the respective output of the multi-output feeding network and the multi-port antenna;
each circulator having a plurality of ports arranged such that the output signal from the multi-output feeding network is communicated to a first port of through the circulator and from the second port of the circulator to the respective port of the multi-port antenna and such that the reflected waves from the respective port of the multi-port antenna are communicated back to the second port of the circulator and through the circulator to a third port of the circulator;
a vector network analyzer for measuring the reflected waves from a selected one of the ports of the multi-port antenna by connecting the third port of the respective circulator while connecting each of the third ports of the remaining circulators to a standard matching load
and a control device for using the measurement of the power of the reflected waves to calculate a value reflection coefficient for all ports of the multi-port antenna and for using the value to effect safety and protection of the RF front-end circuitry and the antenna unit.
